(19) United States
(12) Patent Application Publication
(10) Pub. No.: US 2026/0014823 A1
(43) Pub. Date: Jan. 15, 2026

(54) AUTO HITCHING A TROLLEY TO A VEHICLE USING AN IMAGE SENSOR

(71) Applicant: Ati Motors Inc., Milpitas, CA (US)

(72) Inventors: Venkata Hanuma Sai Teja Tiruvallur, Bengaluru (IN); Sagar Hanumantha, Bengaluru (IN); Saurabh Chandra, Bengaluru (IN); Naveen Arulselvan, Bengaluru (IN)

(73) Assignee: Ati Motors Inc., Milpitas, CA (US)

(21) Appl. No.: 18/771,729

(22) Filed: Jul. 12, 2024

(51) Int. Cl. B60D 1/24; B60D 1/00; B60D 1/04; G05D 1/242; G05D 1/689; G05D 111/10

(52) U.S. Cl. CPC B60D 1/246; B60D 1/04; B60D 1/248; G05D 1/242; G05D 1/689; B60D 2001/005; G05D 2111/14

(57) ABSTRACT

According to embodiments of the present disclosure, a reliable mechanism to autonomously hitch a trolley to a vehicle, e.g., an autonomous mobile robot (AMR) is described herein. The described hitching mechanism includes a camera to accurately position the vehicle, a mechanical setup designed for hitching to the trolley using a latch system with a pin type hitch. The system incorporates an automatic unhitching mechanism and includes a sensing capability to determine whether a trolley has been hitched to a vehicle, e.g., an autonomous mobile robot (AMR), or not. Additionally, the system allows for a high tolerance in the field of view (FOV) for aligning with the trolley hitch.

### TECHNICAL FIELD OF THE INVENTION

This invention in general relates to autonomous mobile robots, and specifically to hitching with autonomous mobile robots.

### BACKGROUND

Trolleys have been used to move material for a long time. Trolleys are typically used for moving a specific load across different surfaces. Different industries create trolleys based on the particular use case for the specific industry. The various objects or loads transported using trolleys in automotive industries include tyres, engines, engine parts, panels, other trolleys (in case of Mother-Daughter trolleys), etc. Autonomous material transportation systems play a pivotal role in streamlining operations in industries and warehouses.

Material movement in industrial environments using trolleys can be automated using self-driving robotic vehicles. However, such automated vehicles still rely on manual interaction at the start and destination, e.g., to load or unload material, to check vehicle state, to charge or replace a vehicle battery, etc.

Loading material on a trolley that is then moved to a different location is a common technique for material movement. Trolleys are typically used for moving specific loads across different surfaces. There is no generic design that exists across all trolleys. Different industries create trolleys based on the particular use case. For example, in the automotive industry, examples of loads transported using trolleys can include tyres, engines, engine parts, panels, other trolleys (in case of Mother-Daughter trolleys), etc.

Various techniques can be employed to move a trolley across a factory floor. For example, trolleys may be moved by human workers, tuggers (electric or internal-combustion engine driven), automated guided vehicles (AGVs), and/or autonomous mobile robots (AMRs).

### SUMMARY OF THE INVENTION

An important aspect of material movement systems that use a vehicle (e.g., AMR, AGV, or other type of vehicle) to tug a trolley is the hitching process, which involves securely connecting an autonomous mobile robot (AMR) (or other vehicle) to a trolley. Traditional manual hitching methods are time-consuming and prone to alignment errors, hindering operational efficiency. Manual hitching process can also lead to safety breaches because the operator may get wedged between the vehicle and trolley when the vehicle starts to move.

A reliable mechanism to autonomously hitch a trolley to a vehicle, e.g., an autonomous mobile robot (AMR) is described herein. The described hitching mechanism enables zero-touch material movement using an autonomous mobile robot or other vehicle. Further, the hitching mechanism can also be used to daisy chain trolleys (e.g., connect two or more trolleys to each other, with one of the trolleys being connected to a vehicle).

A dual-sensor system comprising camera-Lidar is employed to accurately position the vehicle, e.g., autonomous mobile robot (AMR) in alignment with the pin of the trolley. By utilizing computer vision algorithms and image processing techniques, the camera captures the visual information of the hitch area and determines the approximate location of the pin. With the given coarse location of the pin, the Lidar beams can precisely locate the pin. With this novel iterative approach, tracking accuracy of the pin is very high (for example, <2 cm in some implementations).

A mechanical setup designed for hitching to a trolley using a latch system with a pin type hitch is described. The system incorporates an automatic unhitching mechanism and includes a sensing capability to determine whether a trolley has been hitched to a vehicle, e.g., an autonomous mobile robot (AMR), or not. Additionally, the system allows for a high tolerance (e.g., in some implementations, about 150 millimeters or so) in the field of view (FOV) for aligning with the trolley hitch. The automatic unhitching mechanism can simplify the detachment process of decoupling the trolley from the vehicle. This feature eliminates the need for manual intervention, saving time and reducing the risk of human error and safety violations.

Once the pin is detected (within the allowable tolerance, e.g., 150 millimeters or less), the latch system is engaged to securely hitch the robot to the trolley. The mechanical arrangement ensures a reliable connection between the robot and the trolley, enabling safe and efficient material transportation. Furthermore, the system incorporates an automatic unhitching mechanism as well as manual unhitching, allowing for quick and effortless detachment of the vehicle from the trolley when necessary. This can enhance the flexibility and ease of use of the system, enabling seamless transitions between different tasks or operations.

This disclosure describes techniques, including a mechanical setup with advanced features, that address challenges faced in material movement systems that utilize a vehicle coupled to a trolley. The described setup incorporates a latch system and computer vision technology to automate the hitching process. By utilizing a camera-based positioning system, the AMR (or other vehicle) can precisely align itself with a pin hitch of the trolley. The camera-lidar dual sensor system provides hitch tracking with a small tolerance (e.g., <2 cm), allowing for alignment errors to be very small and within tolerable range. In conjunction with the mechanical design of the latch and a sensor suite to monitor operation, the composite system can ensure reliable hitching in dynamic environments when the trolley may be partially occluded due to the presence of other objects. By integrating the described mechanical setup into autonomous material transportation systems, industries and warehouses can optimize their operations, improve productivity, and achieve a higher level of precision and reliability in the hitching process.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of a component referenced by a numeral in a drawing is applicable to the description of that component shown by that same numeral in any subsequent drawing herein.

FIG. 1 illustrates an automatic latch and its various components, in accordance with some implementations.

FIG. 2A illustrates a front view of an automatic latch, in accordance with some implementations.

FIG. 2B illustrates a rear view of an automatic latch, in accordance with some implementations.

FIG. 2C illustrates a top view of an automatic latch, in accordance with some implementations.

FIG. 2D illustrates an isometric view of an automatic latch, in accordance with some implementations.

FIG. 3 illustrates a trolley side hitch system, in accordance with some implementations.

FIG. 4A illustrates vehicle side hitching, in accordance with some implementations.

FIG. 4B illustrates vehicle side unhitching, in accordance with some implementations.

FIG. 5A illustrates a trolley being hitched, in accordance with some implementations.

FIG. 5B illustrates a hitched pin, in accordance with some implementations.

FIG. 6 exemplarily illustrates the range of the sensor fields.

### DETAILED DESCRIPTION OF THE INVENTION

The presently disclosed subject matter now will be described more fully hereinafter with reference to the accompanying figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated figures. Therefore, it is to be understood that the presently disclosed subject matter is not to be limited to the specific embodiments disclosed and that modifications and other embodiments are intended to be included within the scope of the appended claims.

Self-driving vehicles offer many advantages-reduction in expense owing to saving labor costs; suitability for operation in tight spaces where conventional, manually driven vehicles cannot operate; flexibility in design of shape; etc. Self-driving vehicles can operate in both indoor and outdoor environments. The vehicle and associated systems described herein can achieve autonomous movement in limited mapped environments such as private industrial spaces, warehouses, etc.

In an autonomous mobile robot (AMR) or other self-driving vehicle, data from sensors such as a light detection and ranging sensor (LiDAR) and one or more other sensors such as a camera, radar, etc. can be used to accurately detect objects and landmarks in an environment, for e.g., trolley, ramps, speed humps, gangways, storage racks, automation accessories such as trolley hitch, conveyors.

An AMR may be used for material movement. For example, a trolley may be coupled to the AMR.

The auto latch as described herein includes a mechanical setup designed for hitching an autonomous mobile robot (or other vehicle) to a trolley using a latch system with a Pin-type hitch. The primary objective is to provide a reliable and efficient autonomous mechanism for securely connecting the vehicle to the trolley during material transportation operations.

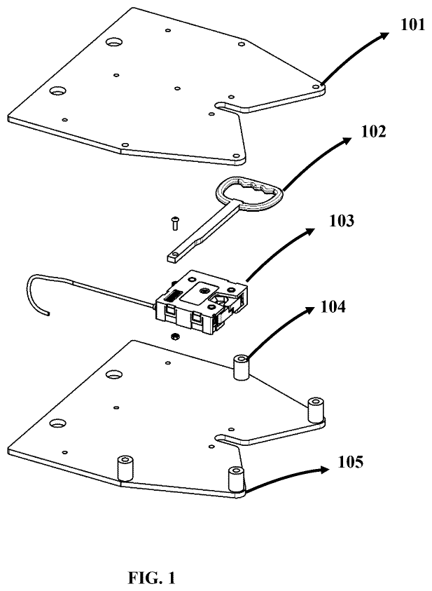

FIG. 1 illustrates an automatic latch and its various components, in accordance with some implementations. The automatic latch includes the following components:

The top plate 101 is a structural component that forms the upper part of the Auto Latch system. It provides support to other components.

User-friendly latch release handle 102 enables the quick and effortless release of the latch mechanism when unhitching the robot from the trolley.

Electromechanical latch 103 ensures a reliable and robust connection between the robot and the trolley.

Spacers 104 used to create a gap or separation between different components of the Auto Latch system.

Bottom plate 105 serves as the lower part of the Auto Latch system. It provides structural support to other components.

The top plate 101 forms the upper part of the automatic latch, providing structural support. The top plate 101 incorporates a user-friendly latch release handle 102, allowing users to easily and conveniently release the latch mechanism for unhitching purposes.

The automatic latch includes an electromechanical latch 103. The electromechanical latch 103 combines electrical and mechanical mechanisms to ensure a secure connection between a vehicle (e.g., an AMR) and a trolley. The electromechanical latch 103 engages with a trolley hitch 303, providing a reliable linkage to withstand the pulling forces during transportation operations. The latch is designed for durability and robust performance, ensuring long-term reliability of the connection.

The primary function of the electromechanical latch 103 is to lock the pin of the trolley 303 and hold it in position. This is accomplished via a jaw mechanism. The latch also auto unlocks, which is achieved via an electric actuator. A sensor (not shown) is used to detect if the pin is locked in position or not.

The pin 303 from the trolley is held in position while the vehicle (e.g., AMR) moves. The pin 303 can be released via an electric signal from the AMR. The pin status is detected to enable safe movement. The electromechanical latch 103 is responsible for this function. The latch has an inbuilt motor that pushes a lever which opens or closes the jaw, subsequently controlling the latch. A proximity sensor is provided that detects the pin and generates a binary signal of ‘ON’ and ‘OFF’ as output. This is used by the AMR to detect if the trolley is latched or not.

Spacers 105 are provided to enable proper alignment and clearance between the different components, optimizing the functionality of the automatic latch. The bottom plate 105 serves as the lower part of the automatic latch, offering structural support to the overall setup.

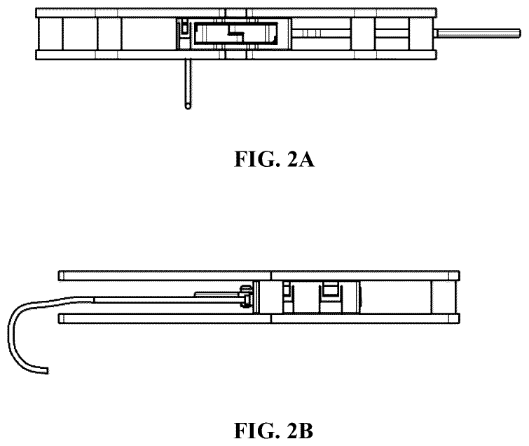

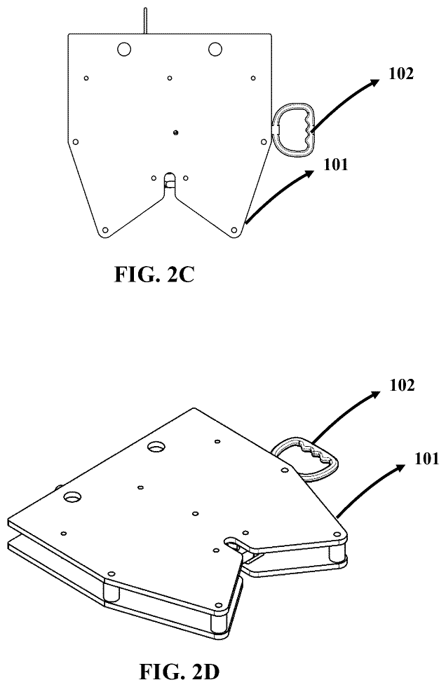

FIG. 2A illustrates a front view of an automatic latch, in accordance with some implementations. The plates housing the Auto-latch has a funnel-type of profile in the front side, terminated by a small notch to lock the Pin-hitch of the trolley.

FIG. 2B illustrates a rear view of an automatic latch, in accordance with some implementations. The top and bottom plate has a flat profile in this view, with mount points to fasten the auto latch onto the vehicle.

FIG. 2C illustrates a top view of an automatic latch, in accordance with some implementations. In turn, this provides the overall footprint of the latch enclosure.

FIG. 2D illustrates an isometric view of an automatic latch, in accordance with some implementations. Mounting holes can be seen in this view.

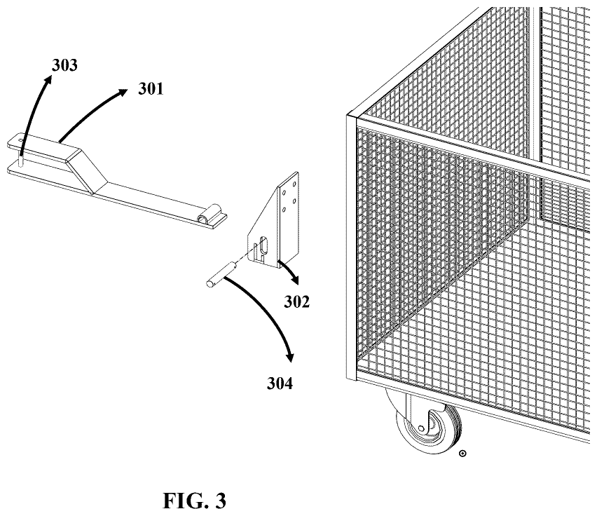

FIG. 3 illustrates a trolley side hitch system, in accordance with some implementations.

Hitch link plate 301: It acts as a connection point between the hitch and the robot, allowing for secure attachment.

Hitch link holder 302: The hitch link holder is a structural element that supports the hitch link plate and helps maintain its position within the trolley hitch system.

Hitching pin 303: The hitching pin is a mechanical pin that serves as the primary connection point between the trolley hitch and the Auto Latch system.

Pivoting pin 304 allows the hitch link plate to pivot.

Trolley mounting points (5): This position is where the hitch link holder is to be mounted on the trolley.

Trolley hitch components are depicted in FIG. 3. The hitch link plate 301 acts as a connection point between the hitch and the vehicle. It provides a secure attachment point for the automatic latch. The hitch link holder 302 supports the hitch link plate, ensuring its stability and positioning within the trolley hitch system.

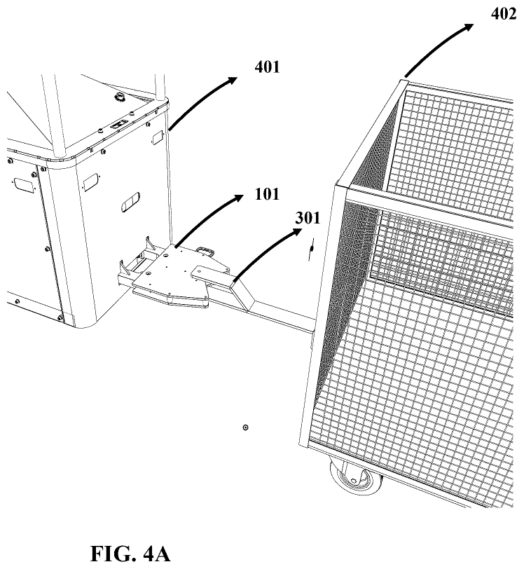

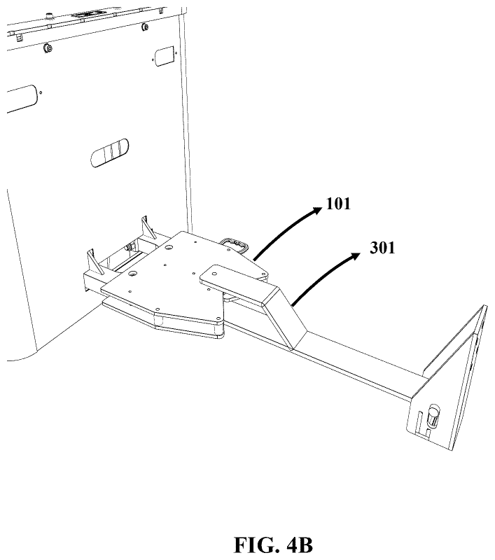

The hitching pin 303 serves as the primary connection point between the trolley hitch and the automatic latch. The hitching pin 303 securely fastens the vehicle to the trolley, maintaining a reliable linkage throughout transportation tasks. The pivoting pin 304 enables rotational movement of the trolley hitch along the z-axis (the rigid vehicle's nominal motion is confined to x-y plane), allowing the hitch link plate 301 to pivot and adjust its position. This facilitates the smooth attachment and detachment of the vehicle from the trolley, enhancing operational flexibility. An on-board microcontroller processes data captured by sensors in the auto-hitching system. FIG. 4A illustrates vehicle 401 side hitching, in accordance with some implementations. In particular, an operational sequence of hitching a trolley 402 to a vehicle (e.g., AMR) is described below with reference to FIG. 4A. The operational sequence is as follows:
Step 1: A trolley fitted with the hitch system as described with reference to FIG. 3 is parked at a predefined location. For example, this is a specified bay in a trolley parking lot.
Step 2: The AMR 401 reaches the trolley 402 location (obtained from user-instruction or an inventory management system, along with the reference map stored in the map) and parks directly ahead of the trolley.
Step 3: The AMR 401 reverses towards the trolley 402 till the hitching pin 303 on the trolley gets locked to the automatic latch 103. The AMR is able to execute this step based on the object tracking algorithm it employs (e.g., using one or more sensors, the AMR detects objects in its vicinity). For example, the AMR can implement a tracking algorithm to locate the trolley using sensor data, e.g., from a 3D LiDAR. The AMR 401 can estimate the pin location coarsely based on such data. The AMR 401 can include a depth-sensing camera. The hitching can be accomplished based on making fine corrections to the estimate of the trolley position using data from the depth-sensing camera (e.g., image of the trolley with the automatic latch and distances to various points on the latch). The algorithm can also be tailored to detect specific profile/hue/texture of the hitching pin 303.
Step 4: Upon confirmation of successful hitching operation from the sensor suite (e.g., 3D LiDAR, depth-sensing camera, a proximity sensor, an accelerometer, a piezoelectric sensor, payload sensing system, etc.), the AMR proceeds to the next destination with the trolley firmly attached via the automatic latch and hitching pin. The confirmation of the successful operation in Step 4 may come from a fusion of sensor inputs such as: a) Proximity sensor to detect the lock position; b) Accelerometer or Piezo-electric sensor to detect the impact caused by the hitching operation; c) Current monitor or payload sensing systems to determine the pulling force post-hitching operation; etc.
Step 5: Upon the determination of unsuccessful hitching from the sensor suite, the AMR may retry steps 3 and 4 or send an alert for manual intervention.

FIG. 4B illustrates vehicle side unhitching, in accordance with some implementations. In particular, an operational sequence of unhitching a trolley is described below with reference to FIG. 4B. The operational sequence is as follows:
Step 1: The AMR along with the hitched trolley reaches the configured destination.
Step 2: The control module of the AMR actuates the electromechanical latch 103 to release the lock. The latch 103 has an inbuilt motor that pushes a lever which releases the claw, subsequently releasing the latch. A proximity sensor looks for the pin and gives a binary signal of ‘ON’ and ‘OFF’ as the output. This is used by the AMR to detect if the trolley is latched or not.
Step 3: Upon confirmation of the lock release, the AMR proceeds to the next destination.

As in the hitching operation, the confirmation of the successful operation in Step 3 may come from a combination of sensors such as a proximity sensor to detect the lock position, a current monitor to check the increased motor current drawn and load-cell to measure increase in pull-force etc.

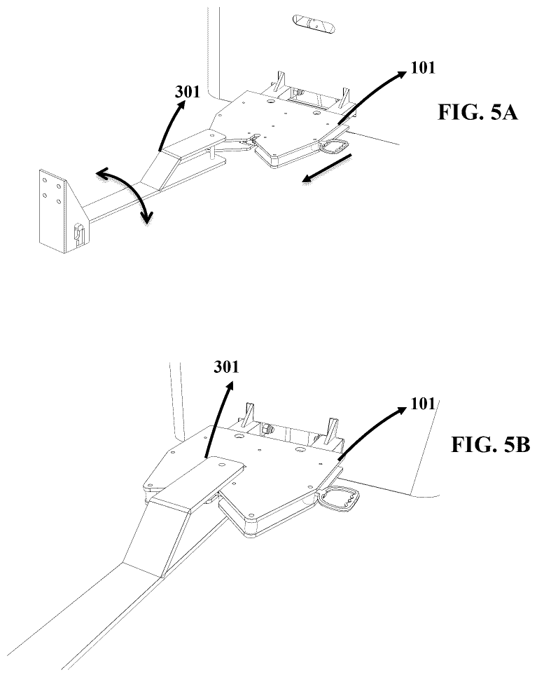

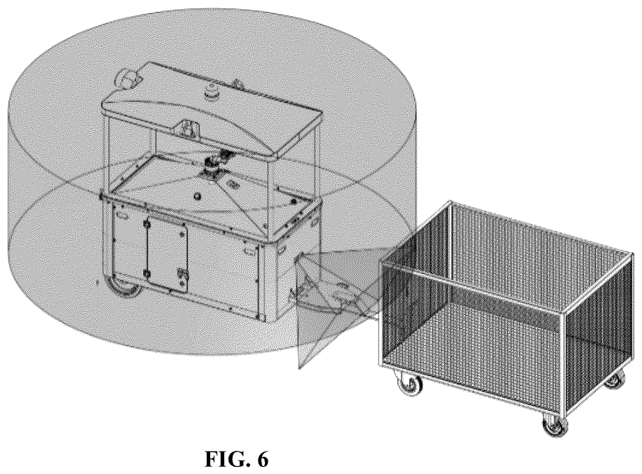

FIG. 5A illustrates a trolley being hitched, in accordance with some implementations. In particular, FIG. 5A shows the interaction between the automatic latch and the trolley hitch as the vehicle (e.g., AMR) reverses. As the AMR approaches closer to the trolley, the funnel-profile of the automatic latch enables the hitching pin 303 on a stationary trolley to slide along till the U-shaped notch of the automatic latch locks the pin.

The notch can be designed with a small tolerance to mate with the circular hitching pin. The funnel in the auto-latch can be symmetric V-shaped. Thus, the hitching pin 303 of the trolley can be approached from either left or right direction. The funnel profile enables the hitching operation to be performed autonomously even when the tracking accuracy of the tracking algorithm of the AMR is low.

FIG. 5B: Illustration of a Trolley being Unhitched

FIG. 5B illustrates a hitched pin, in accordance with some implementations. In FIG. 5B, the pin is hitched to the auto-latch in the vehicle (e.g., AMR). The user has an option to manually override the hitch using a simple lever mechanism in case of error scenarios.

The foregoing examples have been provided merely for explanation and are in no way to be construed as limiting the apparatus disclosed herein. While the apparatus has been described with reference to particular embodiments, it is understood that the words, which have been used herein, are words of description and illustration, rather than words of limitation. Furthermore, although the apparatus has been described herein with reference to particular means, materials, and embodiments, it is not intended to be limited to the particulars disclosed herein; rather, the design and functionality of the apparatus extends to all functionally equivalent methods, structures and uses, such as are within the scope of the appended claims. While particular embodiments are disclosed, it will be understood by those skilled in the art, having the benefit of the teachings of this specification, that the apparatus disclosed herein is capable of modifications and other embodiments may be effected and changes may be made thereto, without departing from the scope and spirit of the apparatus disclosed herein.

1. An automatic latching system between a vehicle and a trolley, comprising:
latching module on said vehicle further comprising:
top plate that forms the upper part of the automatic latch, providing structural support, wherein the top plate incorporates a user-friendly latch release handle, allowing users to easily and conveniently release a latch mechanism for unhitching purposes;
a latch release handle that enables the quick and effortless release of said latch mechanism when unhitching the vehicle from the trolley;
bottom plate that serves as the lower part of said latching module, and that provides structural support to components;
an electromechanical latch that combines electrical and mechanical mechanisms to ensure a secure connection between the vehicle and the trolley, wherein the electromechanical latch engages with a trolley hitch providing a reliable linkage to withstand the pulling forces during transportation operations;
said electromechanical latch locks onto a pin of the trolley and holds it in position using a jaw mechanism, and said electromechanical latch unlocks via an electric actuator;
a pin from the trolley is held in position while the vehicle moves, and said pin can be released via an electric signal from the vehicle and the pin status is detected to enable safe movement;
wherein the electromechanical latch has an inbuilt motor that pushes a lever which opens or closes the claw, subsequently controlling the latch;
a sensor module further comprising:
a proximity sensor that detects the pin and generates a binary signal of ‘ON’ and ‘OFF’ as output, wherein said output is used by the vehicle to detect if the trolley is latched or not;
accelerometer or Piezo-electric sensor to detect the impact caused by the hitching operation;
current monitor or payload sensing systems to determine the pulling force post-hitching operation;
a microcontroller that processes data captured by said sensor module;
plates with a funnel-type of profile in the front side, terminated by a small notch to lock the said pin hitch of the trolley;
a trolley side hitch system on said vehicle, comprising:
a hitch link plate that acts as a connection point between the trolley and the vehicle, allowing for secure attachment;
a hitch link holder that is a structural element that supports the hitch link plate and helps maintain its position within the trolley hitch system;
a hitching pin that serves as the primary connection point between the trolley hitch and an auto latch system, wherein the hitching pin hitching securely fastens the vehicle to the trolley, maintaining a reliable linkage throughout transportation tasks;
a pivoting pin that enables rotational movement of the trolley hitch along the z-axis, wherein the rigid vehicle's nominal motion is confined to x-y plane, whereby by allowing the hitch link plate to pivot and adjust its position, facilitating the smooth attachment and detachment of the vehicle from the trolley and enhancing operational flexibility.

2. The automatic latching system of claim 1, wherein the top and bottom plate have a flat profile, with mount points to fasten the auto latch onto the vehicle.

3. The automatic latching system of claim 1, wherein a circular hitching pin on the trolley locks with a symmetric V shaped latch on the vehicle.

4. The automatic latching system of claim 1, further comprising spacers used to create a gap or separation between different components of the auto latch system.

5. The automatic latching system of claim 1, wherein said vehicle is an autonomous mobile robot.

6. A method of hitching a trolley to a vehicle, wherein operations on the vehicle side comprises the steps of:
reversing the vehicle towards said trolley;
applying a first object tracking algorithm on data generated from a 3D LiDAR to locate a hitching pin position coarsely, and to apply a second object tracking algorithm on data generated from a depth sensing camera to make fine corrections to the estimate of the trolley position;
hitching the vehicle to the trolley with an electromechanical latch;
confirming a successful hitching operation by successfully achieving operations comprising;
detecting a lock position using a proximity sensor;
detecting impact caused by the hitching operation using an accelerometer or piezoelectric sensor;
determining pulling force of the post hitching operation by applying an current monitor or payload sensing system;
retrying said steps of reversing the vehicle and estimating trolley position, or sending an alert for manual intervention, if said step of confirming the hitching operation is not successful.

7. The automatic latching system of claim 6, wherein said second algorithm detects specific profile, hue, and texture of a hitching pin.

8. The automatic latching system of claim 6, wherein said vehicle is an autonomous mobile robot.

9. A method of unhitching hitching a trolley from a vehicle, wherein operations on the vehicle side comprises the steps of:
the vehicle with the hitched trolley reaching the configured destination;
actuating an electromechanical latch to release a lock between said vehicle and said trolley, wherein the latch has an inbuilt motor that pushes a lever which releases the claw, subsequently releasing the latch;
confirming a successful unhitching operation by;
detecting the lock position using a proximity sensor; and
determining the pulling force of a post hitching operation by applying a current monitor to measure the increased motor current drawn, or applying a load cell.

10. The method of claim 9, wherein said vehicle is an autonomous mobile robot accurately that detects the position of said hitched trolley.
